(19) United States
(12) Patent Application Publication
(10) Pub. No.: US 2025/0045240 A1
(43) Pub. Date: Feb. 6, 2025

(54) APPROXIMATE COMPUTING BASED TENSOR PROCESSING UNIT (APTPU)

(71) Applicant: UNIVERSITY OF SOUTH CAROLINA, COLUMBIA, SC (US)

(72) Inventors: Mohammed Elbtity, Lexington, SC (US); Ramtin Mohammadizand, Irmo, SC (US)

(21) Appl. No.: 18/776,872

(22) Filed: Jul. 18, 2024

Related U.S. Application Data
(60) Provisional application No. 63/583,348, filed on Sep. 18, 2023.
(60) Provisional application No. 63/517,465, filed on Aug. 3, 2023.

(51) Int. Cl. G06F 15/80; G06F 5/01

(52) U.S. Cl. CPC G06F 15/8046; G06F 5/015

(57) ABSTRACT

A disclosed approximate tensor processing unit (APTPU) includes two main components: (1) approximate processing elements (APEs) consisting of a low-precision multiplier and an approximate adder, and (2) pre-approximate units (PAUs) which are shared among the APEs in the APTPU's systolic array, functioning as the steering logic to pre-process the operands and feed them to the APEs. Performance of the disclosed APTPU across various configurations and various workloads shows that the disclosed APTPU's systolic array achieves delay, area, and power reductions, while realizing comparable accuracy to previous designs.

### PRIORITY CLAIMS

The present application claims the benefit of priority of U.S. Provisional Patent Application No. 63/517,465, filed Aug. 3, 2023, which is titled Approximate Tensor Processing Unit (APTPU), and the benefit of priority of U.S. Provisional Patent Application No. 63/583,348, filed Sep. 18, 2023, which is titled Approximate Computing Based Tensor Processing Unit (APTPU), and both of which are fully incorporated herein by reference for all purposes.

### BACKGROUND OF THE PRESENTLY DISCLOSED SUBJECT MATTER

The presently disclosed subject matter generally relates to improved Artificial Intelligence (AI) through AI acceleration, and more specifically to the ability to deploy artificial intelligence models on resource/energy-constrained devices.

### I. Introduction

DEEP learning workloads demand high resource utilization and frequent memory accesses, and thus require well-engineered memory bandwidth optimization. Neural networks are an optimal fit for architectures that perform parallel computing with a deeply pipelined network of processing elements (PEs). This has led to the broad adoption of tensor processing units (TPUs) and similarly dataflow-driven pipelines with low global data transfer and high clock frequencies [1].

Conventional TPUs reduce energy consumption and increase performance by reusing the values fetched from memory and registers [2] and thus, also reduce irregular intermediate memory accesses. However, the unceasing scaling of deep learning models continues to increase memory access requirements, which are burdened by far more overhead than arithmetic. Many discriminative neural networks are tasked with learning the probability distribution associated with a dataset, and are thus tolerant to many types of errors. The soft-computing nature of deep learning means that many network architectures can handle errors, approximations, and even learn around them, but this error tolerance remains underutilized in modern accelerators [3], [4].

Eliminating the need to read and write redundant data, such as insignificant bits from weights that lack a meaningful representation of the trained task, provides an opportunity to keep pushing hardware along the same trajectory of neural network model growth [5], [6].

The presently disclosed subject matter (APTPU) relates to a hardware design that accelerates some operations of artificial intelligence models. The subject matter leverages in-exact processing elements that have smaller sizes and consume less power than conventional processing elements, which enables the deployment of artificial intelligence models on small (Internet-of-Things) IOT devices.

### SUMMARY OF THE PRESENTLY DISCLOSED SUBJECT MATTER

The presently disclosed system and corresponding and/or associated methodology relates in part to the present disclosure of approximate processing elements (APEs) that replace direct quantization of inputs and weights for low-precision PEs in TPUs, and further reduce the overhead from each element-wise operation by developing pre-approximate units (PAUs) and sharing them between the APEs. By substantially reducing the critical path delay of a single PE that is typically required in regular, vectorized multiplication, the total processing time of a single forward-pass of data is significantly reduced in large-scale multi-element arrays. We assess the tolerance of a variety of neural networks and datasets to our approach to arithmetic approximation, and show negligible classification accuracy degradation, and even an improvement in several instances.

For some embodiments, we disclose an approach to tiling APEs, and present the approximate tensor processing (APTPU), in which, we use the dynamic range unbiased multiplier (DRUM) [7] as a representative logarithmic multiplier and a lower-part OR adder (LOA) [8] to handle the accumulation operation in the multiply and accumulation (MAC) units. In doing so, we achieve a fair balance between accuracy, area, and power consumption. Our APTPU demonstrates up to 5.2× and 4.4× improvements in terms of TOPS/mm2 and TOPS/W compared to a conventional TPU implemented in-house, while obtaining comparable accuracy.

One exemplary embodiment of presently disclosed subject matter relates to a neural network approximate tensor processing unit (APTPU) based systolic array architecture. Such architecture preferably comprises input memory having stored data; data queues; a controller for managing the transfer of stored data from the input memory to the data queues; a plurality of approximate processing elements (APEs) each respectively including a low-precision multiplier and an approximate adder; and a plurality of pre-approximate units (PAUs) which are respectively shared among the APEs in the systolic array.

It is to be understood that the presently disclosed subject matter equally relates to associated and/or corresponding methodologies. One exemplary such method relates to methodology for operating an approximate tensor processing unit (APTPU) systolic array for improved neural network Artificial Intelligence (AI) through AI acceleration. Such methodology preferably may comprise providing a plurality of approximate processing elements (APEs) each respectively including a low-precision multiplier and an approximate adder; and providing a plurality of pre-approximate units (PAUs) which have integrated shareable approximate circuit components which are re-used among the approximate processing elements (APEs) in the systolic array, wherein the PAUs comprise steering logic to pre-process operands input to the systolic array and feed them to the APEs.

Another exemplary such method relates to methodology for a neural network approximate tensor processing unit (APTPU) based systolic array architecture. Such methodology preferably comprises providing input memory having stored data; providing a plurality of data queues; providing a controller programmed for managing the transfer of stored data from the input memory to the data queues; providing a plurality of approximate processing elements (APEs) each respectively including a low-precision multiplier and an approximate adder; and providing a plurality of pre-approximate units (PAUs) which are respectively shared among the APEs in the systolic array.

Other example aspects of the present disclosure are directed to systems, apparatus, tangible, non-transitory computer-readable media, user interfaces, memory devices, and electronic devices for improved neural network Artificial Intelligence (AI) through AI acceleration. To implement methodology and technology herewith, one or more processors may be provided, programmed to perform the steps and functions as called for by the presently disclosed subject matter, as will be understood by those of ordinary skill in the art.

Some estimates have projected the AI hardware market to reach a value of over $20 to $30 billion by 2025. The presently disclosed APTPU advantageously reduces latency, power, cost, and size of AI chips.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

The remainder of this present disclosure is organized as follows. Section II provides the required background of the disclosed subject matter including a brief description of TPU architecture and prior approximate logic circuits. Section III describes the building blocks of the disclosed APTPU architecture. Comprehensive simulation and synthesis results, as well as comparisons with previous works, are provided in Section IV. Finally, section V concludes the present disclosure and discusses potential future work.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 diagrammatically illustrates an exemplary embodiment of presently disclosed APTPU architecture, including five main components: weight/IFMAP memories, FIFOs, a controller, pre-approximate units (PAUs), and approximate processing elements (APEs);

FIG. 2(a) schematically illustrates an exemplary embodiment of the presently disclosed architecture of an exemplary Pre-Approximate Unit (PAU);

FIG. 2(b) illustrates an exemplary Table of a presently disclosed signed to unsigned (S2U) unit exemplary embodiment of the exemplary PAU;

FIG. 2(c) illustrates an exemplary Table of a presently disclosed lead one detector (LOD) exemplary embodiment of the exemplary PAU;

FIG. 2(d) illustrates an exemplary Table of a presently disclosed priority encoder exemplary embodiment of the exemplary PAU;

FIG. 2(e) illustrates an exemplary Table of a presently disclosed bit selector block exemplary embodiment of the exemplary PAU;

FIG. 2(f) illustrates an exemplary Table of a presently disclosed shift amount calculator exemplary embodiment of the exemplary PAU;

FIG. 3(a) schematically illustrates an exemplary embodiment of the presently disclosed architecture of an exemplary Approximate processing element (APE);

FIG. 3(b) illustrates an exemplary Table of a presently disclosed low precision k-bit multiplier unit exemplary embodiment of the exemplary APE;

FIG. 3(c) illustrates an exemplary Table of a presently disclosed adder unit exemplary embodiment of the exemplary APE;

FIG. 3(d) illustrates an exemplary Table of a presently disclosed barrel shifter unit exemplary embodiment of the exemplary APE;

FIG. 3(e) illustrates an exemplary Table of a presently disclosed unsigned to sign block unit exemplary embodiment of the exemplary APE;

FIG. 4(a) schematically illustrates an exemplary embodiment of the presently disclosed architecture of an exemplary lower-part OR adder (LOA) accumulator;

FIG. 4(b) is an exemplary algorithm for the presently disclosed APTPU Approximate MAC Unit;

FIG. 4(c) is a Table which lists the NMED values obtained for different combinations of S, n, and k, and in particular is a Table of normalized mean error distance (NMED) of the presently disclosed APTPU over 1,000 matrix multiplications;

FIG. 5(a) is a schematic of a model architecture for MLP-5 for IMDB classification;

FIG. 5(b) is a schematic of a model architecture for LeNet-5 for MNIST, FMNIST, and EMNIST classification;

FIG. 5(c) is a Table of bit precision comparison for APTPU vs. TPU accuracy;

FIG. 5(d) is a Table of the accuracy obtained by baseline TPU with low precision MAC units without presently disclosed approximation;

FIG. 5(e) is a Table exhibiting comparisons of the area and power consumption for each of the indicated processing elements (PEs);

FIGS. 6(a) and 6(b) graphically represent hardware implementation results for power consumption (FIG. 6(a)) and area (FIG. 6(b)), respectively;

FIG. 6(c) is a Table showing the power consumption and area occupation of the APTPU compared to the baseline TPU;

FIG. 6(d) is a Table showing performance comparisons between APTPU, DRUM-TPU, and baseline TPU for various systolic array sizes in terms of giga operation per second (GOPS);

FIGS. 7(a)-7(d) graphically illustrate the total execution time for various ML models for various Sand n values, specifically for various deep learning models on baseline TPU, DRUM TPU and APTPU, including MLP5 (FIG. 7(a)), LeNet-5 (FIG. 7(b)), YOLO-Tiny (FIG. 7(c)), and MobileNet (FIG. 7(d)), respectively;

FIG. 7(e) is a Table providing performance comparisons between the TPU, DRUM-TPU, and APTPU, for S=64×64 using different IFMap/W bitwidths (n), and multiplier precision resolution (k);

FIG. 7(f) is a Table listing the area and power consumption of our presently disclosed APTPU, including the entire system components, compared to the baseline TPU, all for various systolic array sizes;

FIGS. 8(a)-8(e) graphically illustrate the execution time (T) of various workload on TPU, DRUM TPU, and APTPU, assuming S=64×64 and n=8, including very large (100 ms<T<1s) (FIG. 8(a)), large (10 ms<T<100 ms) (FIG. 8(b)), Medium (1 ms<T<10 ms) (FIG. 8(c)), Small (0.1 ms<T<1 ms) (FIG. 8(d)), and Very small (0.01 ms<T<0.1 ms) (FIG. 8(e)), respectively;

FIG. 9 illustrates a plan view showing a presently disclosed in-house implemented TPU chip layout and exhibiting the placement of the systolic array component on an entire layout;

FIG. 10 is a Table showing comparisons between our presently disclosed APTPU and other approximate systolic arrays for which the design hyperparameters are set as S=32×32, n=8, and k=5; and

FIG. 11 is a Table of comparisons between our presently disclosed APTPU and OUORA approach in [6], expressed for a systolic array of the size S=16×16, n=32, k=8, and FIFO depth=64, while constraining the design to work under 250 MHz.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the presently disclosed subject matter relates to improved Artificial Intelligence (AI) through AI acceleration, and more specifically to the ability to deploy artificial intelligence models on resource/energy-constrained devices.

The presently disclosed approximate computing-based tensor processing unit (APTPU) utilizes logarithmic multipliers in an innovative way, which divides them into two components and uses them in the internal design of the approximate processing elements (APEs) as well as the pre-approximate units (PAUs). APEs have low-precision multipliers and accumulators while PAUs function as the steering logic to pre-process the operands and feed them to the APEs. Both APEs and the shared PAUs together build a systolic array that is used to execute Matrix-Matrix Multiplication as well as Matrix-Vector Multiplication operations in a deep neural network model. Separating PAUs and sharing them among the APEs result in shorter critical path delay (thus higher frequency), less area occupation (and fewer resources on the FPGA), and less power consumption, compared to the conventional low-precision TPU.

The entire architecture of the subject APTPU in some embodiments is preferably implemented in fully parametrized and highly flexible Verilog code that can be used to design any size of the systolic array with any bit precision APEs with the flexibility to use any logarithmic multiplier. Embodiments of different sizes of systolic arrays (ranges between 8×8 and 64×64) with different base multiplication operation precision (8, 16, and 32 bits), and with low-precision multipliers of sizes 3, 4, 5, and 6 bits demonstrated 2.5× and 1.2× reduction in area and power, respectively, compared to the in-house implemented conventional TPU. Additionally, some of the presently disclosed APTPU hardware realized 1.58×, 2×, and 1.78×, reductions in latency, power, and area, respectively, compared to the state-of-the-art systolic arrays while maintaining the same design specification and synthesis constraints.

On the Deep Neural Network accuracy side, the presently disclosed design achieved minimal loss and some gains for different datasets (for example, MNIST, FMNIST, IMDB, and EMNIST) with different bit-precision with post-quantized models with no retraining required.

### II. Background

### A. Tensor Processing Unit

The TPU architecture includes an array of PEs consisting of MAC units which implement matrix-matrix, vector-vector and matrix-vector multiplications. By using the systolic array, the TPU aims to reduce energy consumption and increase performance through reusing the values fetched from memory and registers [2] and thus, reducing the reads and writes from/to the buffers. Input data is fed in parallel to the array, and typically propagates in a diagonal wavefront [1], [9]. The microarchitecture of the MAC unit determines the data flow throughout the systolic array, and each data flow instruction influences power consumption, hardware utilization, and performance.

The dataflow pipeline is optimized to process a large number of MACs in parallel, which is the dominant operation in the forward pass of a neural network. A variety of data flow algorithms have been disclosed, and can be broadly classed as input stationary data flow (IS) [10], weight stationary (WS) [1], output stationary (OS) [11], row stationary (RS) [12], and no-local reuse (NLR) [13], [14]. In the WS regime, each weight is pre-loaded onto a MAC unit. At each cycle, the input elements to be multiplied by the pinned weights are broadcasted among the MAC units within the array, producing partial sums every clock cycle. This process is vertically distributed over columns to generate the results from the bottom of the systolic array [1]. An almost identical process takes place for IS data flow, where the inputs are the fixed matrix and the weights are distributed horizontally. For OS data flow, outputs are pinned to the MAC units while the inputs and weights are propagated among the MAC units. For further details about the TPU's dataflow architecture, readers can refer to [15].

### B. Approximate MAC Units

Several approximate MAC units have been disclosed as alternatives for accurate multipliers and adders to leverage their power and area merits [7], [16], [17], [18], [19], [20], [21], [22], [23] and their potential in deep learning acceleration has been well-explored [24], [25], [26]. MAC units consist of two arithmetic stages, each of which may be approximated independently: multiplication, followed by accumulation with prior products.

1) Approximate Multipliers: Most approximate multipliers, including logarithmic multipliers, consist of two main components: low-precision arithmetic logic and a pre-processing unit which functions as the steering logic that prepares the operands for low-precision computation [7], [27]. Notable approximate multipliers trade-off between accuracy and power efficiency. For instance, the logarithmic multiplier disclosed in [28] prioritizes accuracy, while the multipliers in [29] and [27] are optimized for power and delay efficiency.

Drawing inspiration from approximate image compression accelerators, approximate Booth multipliers have been used for face detection in a convolutional neural network (CNN) accelerator enabling a high throughput [30], [31]. While acceptable performance was found for a set of computer vision tasks, Booth multipliers are likely to struggle in architectures that propagate and accumulate error signals through many layers, as is the case with recurrent and sequential models. This issue arises because Booth multipliers do not have symmetric error distributions centered around zero. While this may be tolerable for signal filtering and shallow networks, modern deep learning architectures may not be so tolerant to error propagation. In our APTPU design, without loss of generality, we employ the dynamic range unbiased multiplier (DRUM) [7] as a representative approximate multiplier. Not only is DRUM a well-known design that achieves a fair balance between accuracy, area, and power consumption, it also remains unbiased across multiple computational steps. When applied to systolic arrays where processing elements are reused, the error can be averaged out and reduced over multiple cycles which leads to better performance of more complex deep learning models as shown in Section IV.A. Nonetheless, other logarithmic multipliers can also be leveraged in the APTPU architecture by separating their steering logic and arithmetic logic parts into two separate blocks, as is explained in the next section.

2) Approximate Adders: Following multiplication, the resulting products must be accumulated with prior products to implement a MAC operation. The accumulation step can also be approximated using approximate adders. Various approximate adder designs have been widely disclosed in the literature accomplishing power, area, and performance improvements [8], [32], [33], [34], [35], [36], [37]. Most approximate adders utilize the fact that the extended carry propagation rarely occurs, and thus adders can be divided into independent sub-adders to speed up the critical path. Moreover, to maintain the computation accuracy, the approximation occurs on the least significant bits of the operands, while keeping the most significant bits accurate. Here, we use a lower-part OR adder (LOA) [8] to handle the accumulation operation in the MAC units, which has been proven to yield acceptable performance in image detection [30]. This will be described in greater detail in the next section and assessed on a broader range of networks and tasks in Section IV.

### III. Disclosed APTPU Architecture

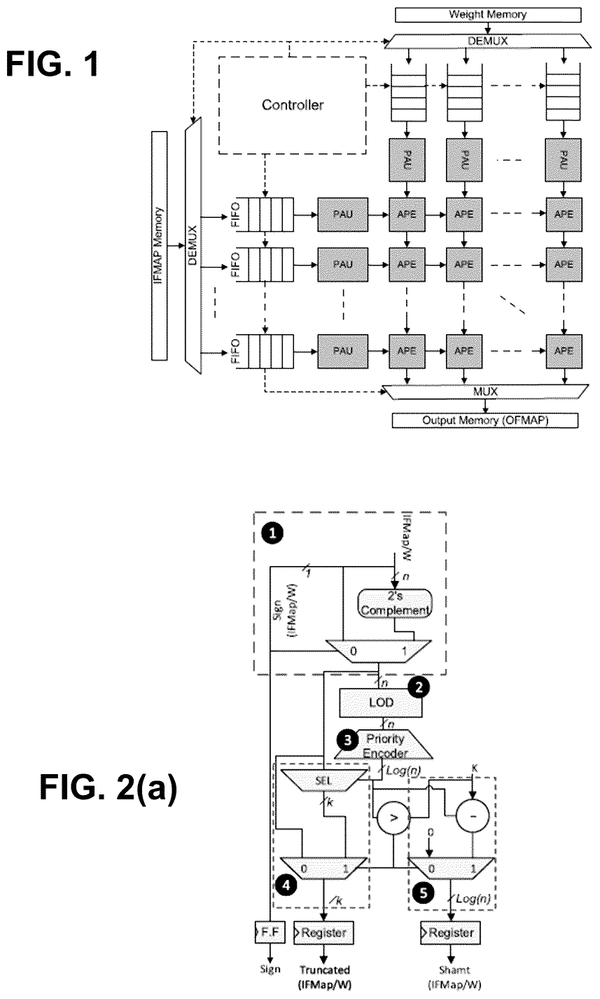

The architecture of our disclosed APTPU is classified as an output stationary (OS) systolic array, in which both the input feature map (IFMap) and weights are streamed into the APEs. This allows concurrent approximation of both the input and weight values within the APTPU architecture. In contrast, in the WS/IS data flow architectures, only the inputs or weights are streamed in the systolic array. FIG. 1 demonstrates the overall architecture of the disclosed APTPU which consists of five main components: weight/IFMap memory, FIFOs, a controller, pre-approximate unit (PAUs), and approximate processing elements (APEs).

The neural network model's weights and inputs are stored in the weight memory and IFMap memory, respectively. The controller manages accesses performed on the memory and the process of transferring the weights and IFMaps to the FIFOs according to the OS data flow algorithm. In the exemplary disclosed APTPU architecture, we develop PAUs to handle the steering logic in approximate multipliers, in which operands with high precision (e.g., 32 bit) are dynamically truncated to low precision (e.g., 4 bit) ones and transferred to APEs that include a low precision multiplier, a Barrel shifter, and an approximate adder to realize the MAC operations. In most of the conventional approximate systolic array architectures [5], [38], [39], the exact MAC units in PEs are simply replaced by approximate MAC units. However, this leads to an increased critical path in PEs, and therefore, lower operating clock frequency and consequently a reduction in the total performance as each of the PEs in the systolic array is designed to perform the MAC operation in one clock cycle.

One exemplary main aspect of the disclosed APTPU architecture is separating the steering logic of approximate multipliers and handling it outside the PEs in a separate PAU block, which reduces the critical path of PEs. Moreover, since the PAUs are responsible for truncating the operands, they could be placed between FIFOs and APEs on the path of the data stream flow to convert the high-precision operands, received from FIFO, to the low-precision ones transferred to the APEs. Thus, instead of using one PAU for each APE, we can share them among the PEs across different rows and columns of the systolic array. This approach adds an extra step (clock) compared to the conventional approximate systolic arrays, however, the reduction in the critical path delay is so significant that it results in overall performance improvements as is exhibited in Section IV. The details of our disclosed PAU and APE architectures are described in the following.

### A. Pre-Approximate Unit (PAU)

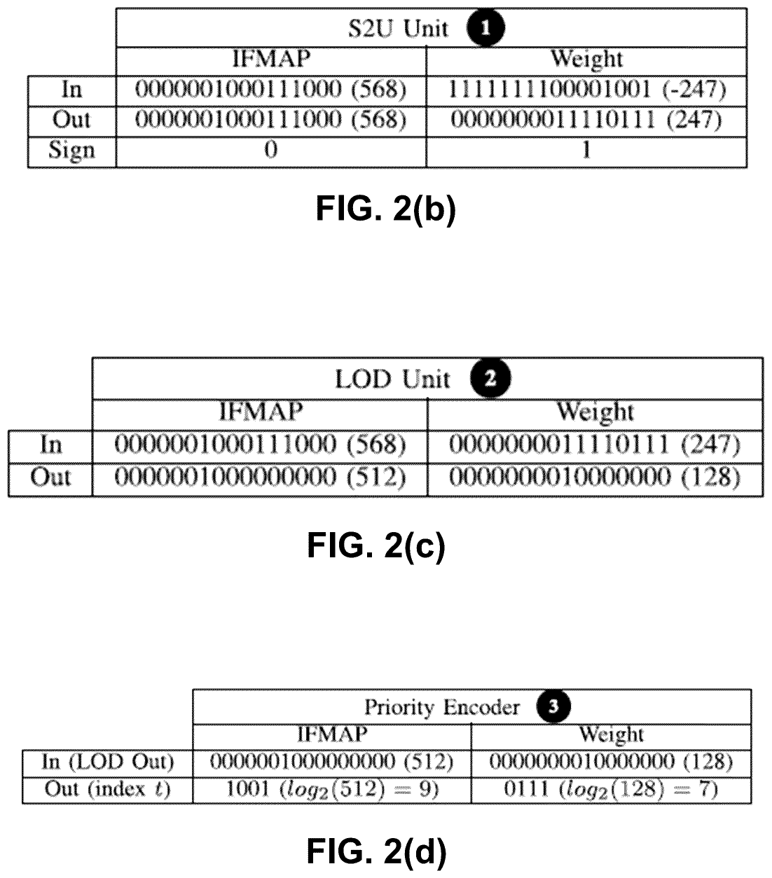

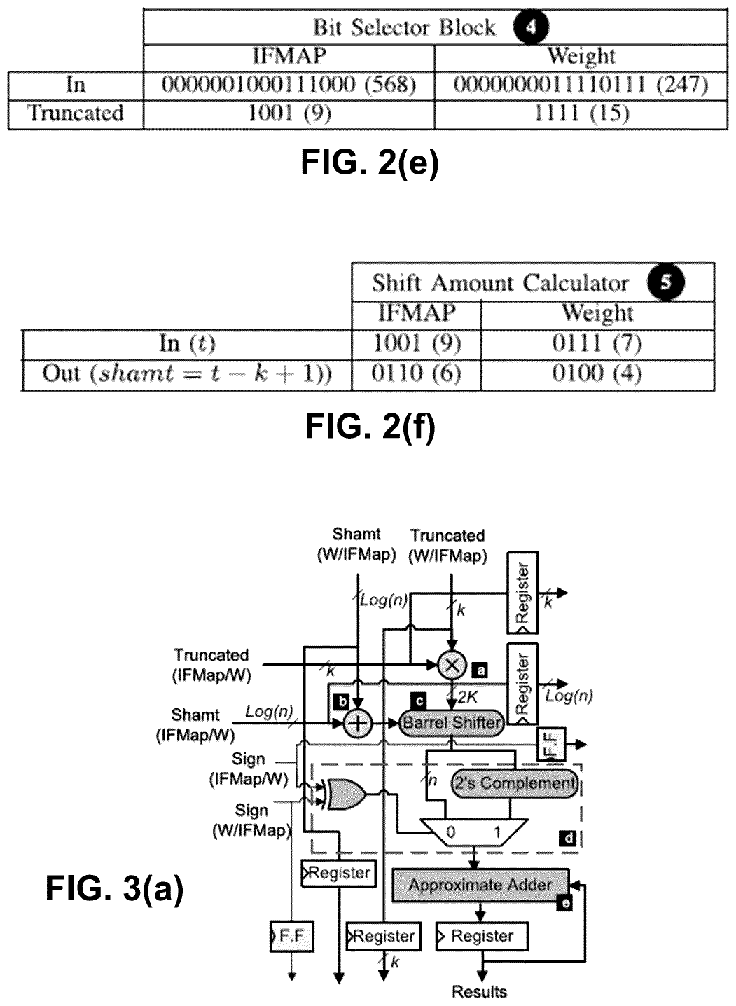

FIG. 2(a) schematically illustrates an exemplary embodiment of the presently disclosed architecture of an exemplary Pre-Approximate Unit (PAU). In the following, we describe the functionality of PAU's building blocks using a numerical example, i.e., IFMap=568 and Weight=−247, assuming that the low-precision multiplier resolution (k) and IFMap/W bitwidths (n) are 4 and 16, respectively.
1) The signed to unsigned (S2U) unit generates the unsigned versions of the IFMap and weight along with its sign, as represented by the Table of FIG. 2(b);
2) The lead one detector (LOD) receives the S2U unsigned output and locates its leading HIGH bit, as represented by the Table of FIG. 2(c);
3) The priority encoder receives the LOD output and generates the log₂( ) of it which represents the index of the lead HIGH bit (t) of the IFMap/Weight. This value is used to control the selector (SEL) as well as calculating the shift amount (shamt_{IFMap/W}), as represented by the Table of FIG. 2(d);
4) Next, per the bit selector exemplary embodiment of the exemplary PAU, as represented by the Table of FIG. 2(e), the unsigned IFMap/W is truncated starting from the bit at index t to index t−k+2. The value at index t−k+1 is set to “1” to compensate for the error caused by removing the bits from index t−k to 0, where k is the pre-defined resolution of the low precision multiplier in the APE architecture. If t>k, then the selector selects the truncated unsigned IFMap/W and feeds it to the APE. Otherwise, no truncation occurs and the unsigned IFMap/W is transferred directly to the APE. This occurs when the operand is sufficiently small to fit within the resolution of the low precision multiplier in the APE, which mitigates the unnecessary loss of accuracy due to the approximation step; and
5) Finally, per the shift amount calculator exemplary embodiment of the exemplary PAU, as represented by the Table of FIG. 2(f), if t>k, then Shamt_{IFMap/W} is equivalent to t−k+1, otherwise, there are no shifts required and Shamt_{IFMap/W}=zero is passed to the APE.

Thus, as shown in FIG. 2(a) through 2(f), each PAU unit is equipped with registers to keep its critical path as small as the APE, thus enabling an increased clock frequency.

### B. Approximate Processing Element (APE)

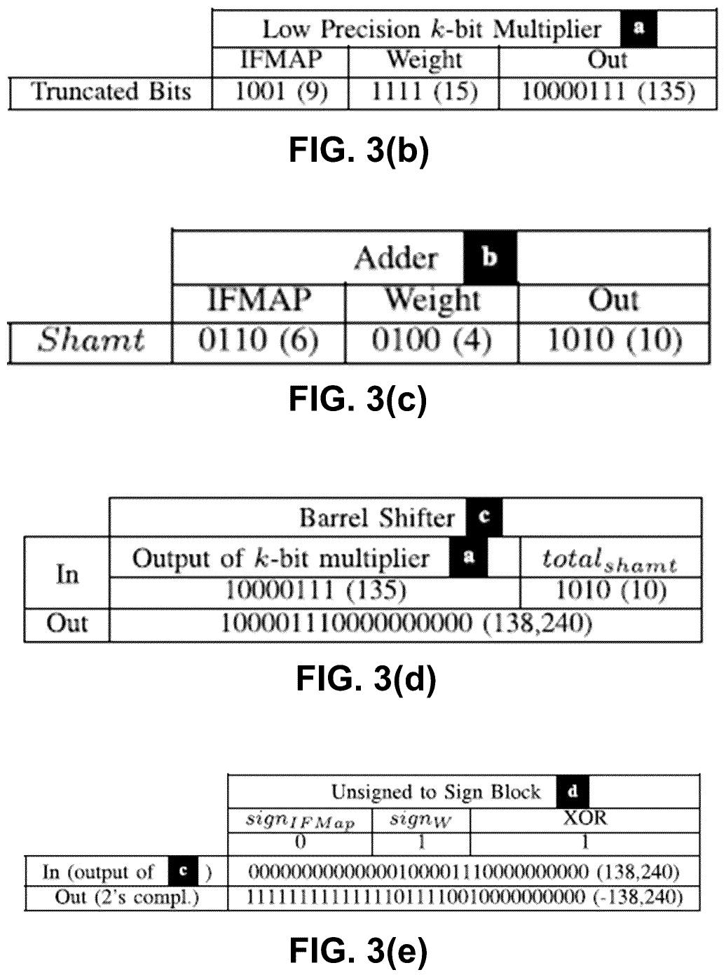

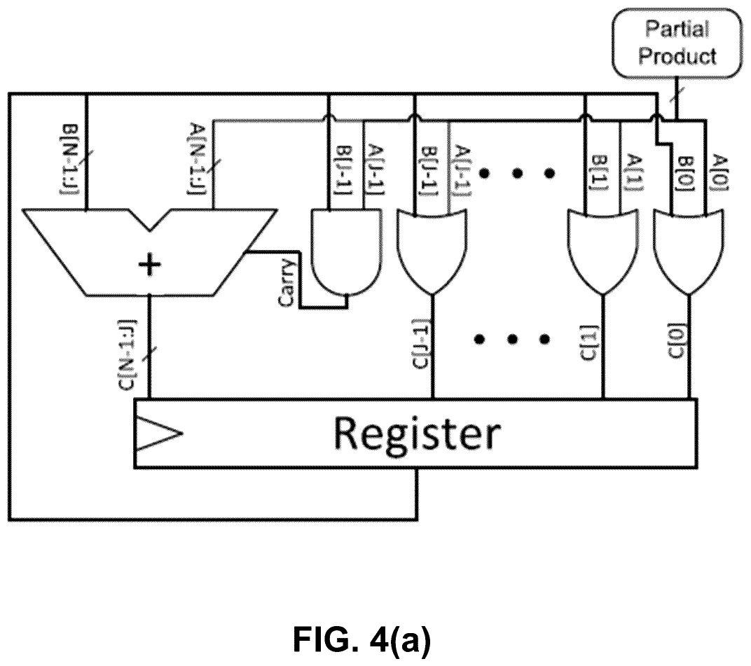

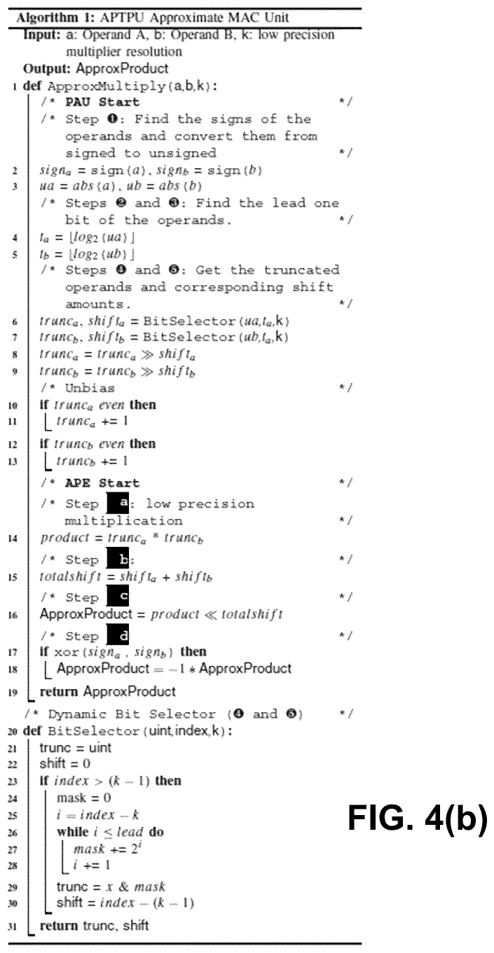

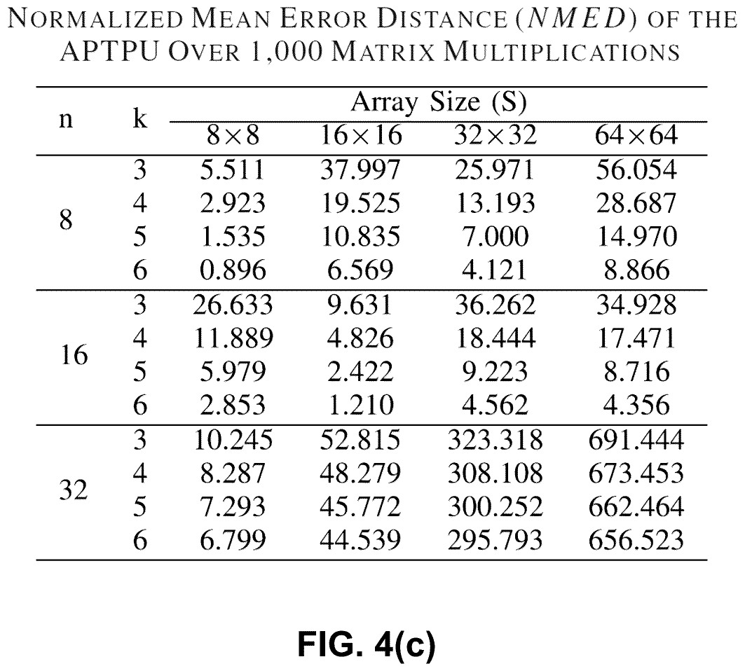

FIG. 3(a) schematically illustrates an exemplary embodiment of the presently disclosed architecture of an exemplary Approximate processing element (APE). The presently disclosed APE receives the truncated bits, shift amount, and the sign of each operand from the corresponding PAUs, and then performs the MAC operation. The architecture of the APE as shown in FIG. 3(a) is described as follows:
1) The truncated bits trunc IFMap/W are multiplied using the low precision k-bit multiplier, as represented by the Table of FIG. 3(b), and the product is sent to the barrel shifter (FIG. 3(d));
2) The shift amount Shamt_{IFMap/W} received from the PAUs are added, as represented by the Table of FIG. 3(c), to generate the totalₛₕₐₘₜ amount;
3) The barrel shifter shifts the low precision multiplier result to the left by the totalₛₕₐₘₜ value, as represented by the Table of FIG. 3(d);
4) The unsigned output of the barrel shifter is converted to a signed value using the XOR of the sign_{IFMap/W} bits fed from the PAUs, as represented by the Table of FIG. 3(e);
5) A lower-part OR adder (LOA) [symbol] is used to build the accumulator of the MAC unit, as represented by the schematic architecture as represented in FIG. 4(a). The LOA consists of an array of OR gates with no carry propagation for the J least significant bits, i.e., A[J−1:0] and B[J−1:0], as well as an accurate adder that adds the most significant N−J bits of the operands, i.e., A[N−1:J] and B[N−1:J]. To increase the computational accuracy of this adder, an AND gate is used to generate the input carry for the accurate adder. The key advantage of the LOA is that the error is restricted to the least significant bits of each operand. The total bitwidth of the LOA accumulator (N) depends on the size of the systolic array (S) and IFMAP/W bitwidth (n) as expressed below,

$$N = 2 n + {log}_{2} ( S ) \qquad ( 1 )$$

In our design, we use 25% of the total bitwidth of LOA as the bitwidth of the approximate part, i.e., J=N/4.

### C. APTPU Operation and Timing

The first step in APTPU operation is to store the IFMAPs and weights into the FIFOs, which is handled by the controller through DEMUX circuits. A Write_{enable} signal is asserted to the input port of each FIFO and the data is transferred from memory to the FIFOs according to the OS dataflow. The depth of each FIFO in an APTPU architecture with a systolic array size (S) of M×M is defined as,

$${FIFO}_{D epth} = 2 M - 1 \qquad ( 2 )$$

The number of clock cycles required to write the input and weight data into the FIFOs using two DEMUX circuits working in parallel can be calculated based on the equation below:

$${FIFO}_{Cycles} = {FIFO}_{D epth} \times M = 2 {M}^{2} - M \qquad ( 3 )$$

After storing the input and weight data to all FIFOs, the controller asserts the Read_{enable} signal to each FIFO, and a new IFMAP/weight data is read in each clock cycle and transferred to the PAU blocks. The PAUs complete their task in one clock cycle and transfer data to the APEs. Typically, in an M×M output stationary systolic array, it takes M clock cycles to calculate the first element in the output matrix, and 3M−2 clock cycles to compute the last element [15]. However, since the disclosed APTPU has an additional step for the PAU operation, the first element of the output matrix gets ready after M+1 clock cycles, while the last element is ready after 3M−1 cycles. For example, in a S=8×8 systolic array, it takes 9 and 23 cycles to compute the first and last element in the output matrix, respectively.

### D. Disclosed Python Implementation for APTPU

To enable running machine learning (ML) applications on the disclosed APTPU architecture without requiring an actual hardware implementation, we developed a Python program that implements the APTPU's functionality and implements the approximate multipliers as described in FIG. 4(b) (which is an exemplary algorithm for the presently disclosed APTPU Approximate MAC Unit). Similar to the APTPU architecture, the algorithm is divided into a PAU function followed by an APE function. In step 1, equivalent to [symbol] in the PAU architecture, the signed to unsigned conversion happens through an absolute (abs) function. To find the index of the lead one bit (t) in the operands, the blocks [symbol] and [symbol] of the PAU are implemented by applying the floor function (└x┘) to log₂ of the operands. Next, a BitSelector function is created that receives the unsigned operands, index t, and resolution of the low precision multiplier (k) as inputs and returns the truncated operands and total shift amounts corresponding to steps [symbol] and [symbol] of the PAU, respectively. The APE function in the python program uses the truncated operands and shift amounts obtained by the PAU function to calculate the approximate output as shown in lines 14 to 19 of the algorithm.

### IV. Simulation Results and Discussions

To assess the performance and accuracy of our APTPU, we used a variety of deep learning models and datasets. We benchmarked accuracy, power, area, timing, tera-operations per-second (TOPS), TOPS per-watt (TOPS/W) and TOPS per-mm² (TOPS/mm²) across the parameter space of 8, 16 and 32 bits for IFMap/W precision (n) with the resolution of the low-precision multiplier (k) within the APE spanning from 3 to 6 bits, as described in the following subsections.

### A. Error Analysis and Error-Tolerant Applications

Herein, we provide a system-level error analysis for the APTPU architecture and investigate its accuracy for some error-tolerant applications to demonstrate its applicability in practical scenarios.

1) Error Analysis: To measure the error introduced by the APTPU architecture at the system level, we simulated matrix multiplications using the developed Python program for the APTPU with varying sizes of arrays (S), integers bit widths (n), and low-precision multiplier resolution (k). We performed 1,000 randomly generated matrix multiplications for each of the S=M×M, n, and k combinations. To compute the error resulting from the use of APTPU compared to that of the exact TPU, we utilize a normalized version of the average Mean Error Distance (MED_{avg}) introduced in [5] as expressed in Equation 4,

$$\begin{matrix}NMED = \frac{{MED}_{avg}}{\vert Avg ( {P}_{exact} ) \vert} \\ = \frac{\sum [ \vert ( {P}_{exact} ) ( i , j ) - {P}_{approx} ( i , j ) \vert ]}{M \times M \times \vert Avg ( {P}_{exact} ) \vert}\end{matrix} \qquad ( 4 )$$

where NMED is the normalized MED_{avg}, and P_{exact} and Pₐₚₚᵣₒₓ are the products of matrix multiplication using non-approximate TPU, and APTPU, respectively.

This metric allows the error to be analyzed with respect to the ratio between the MED_{avg} and the average value inside the matrices to allow for the error metrics to be comparable between different values of Sand n. FIG. 4(c) is a Table which lists the NMED values obtained for different combinations of S, n, and k, and in particular is a table of normalized mean error distance (NMED) of the presently disclosed APTPU over 1,000 matrix multiplications. As seen in the FIG. 4(c) Table, as the resolution of low-precision multiplier (k) increases, the error decreases in all matrix sizes with the minimal error being accomplished at k=6. We can also see that, in general, as the size of the matrix and input bitwidth (n) increase the error does as well.

2) Error-Tolerant Application: To investigate the applicability of the disclosed APTPU in practical applications, we utilize the disclosed design for a sentiment analysis application using IMDB movie review dataset, as well as three different image classification tasks including the MNIST handwritten digits [40], EMNIST handwritten letters [41], and Fashion MNIST [42]. The three image datasets were trained on LeNet-5 [40] CNN architecture. For IMDB dataset, we used an MLP-5 dense network with five fully-connected layers.

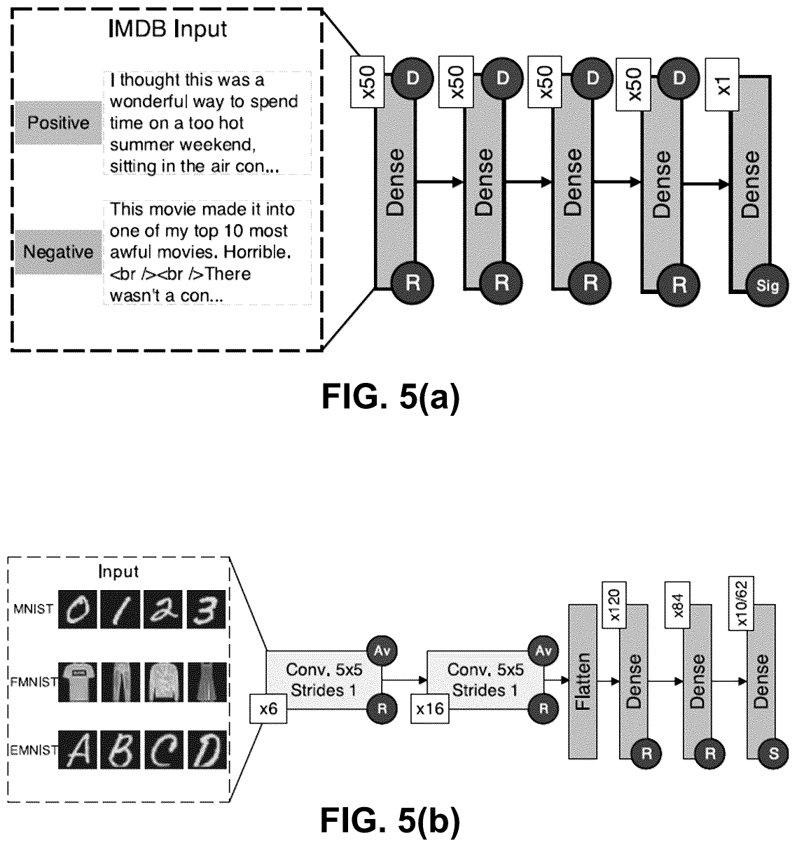

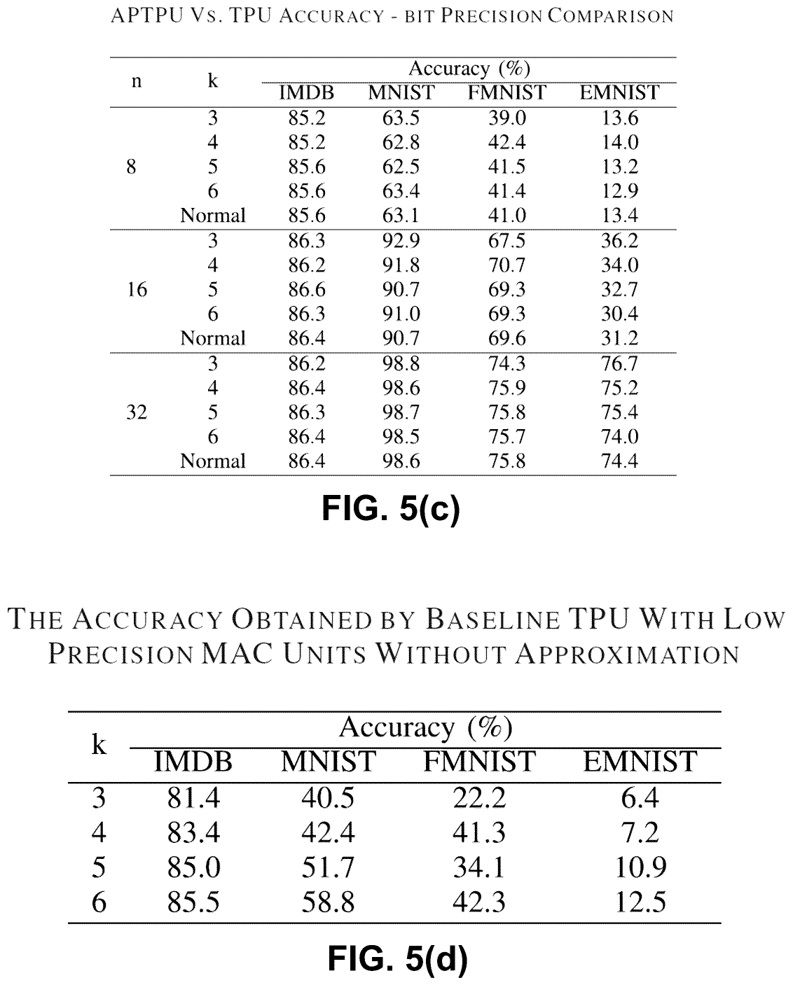

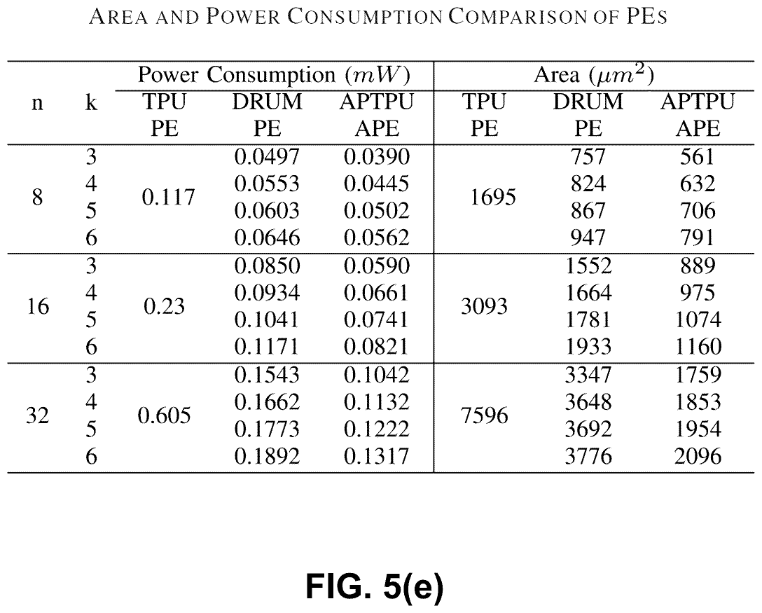

A detailed description of both architectures is provided in FIGS. 5(a) and 5(b). In particular, FIG. 5(a) is a schematic of a model architecture for MLP-5 for IMDB classification, and FIG. 5(b) is a schematic of a model architecture for LeNet-5 for MNIST, FMNIST, and EMNIST classification. In FIGS. 5(a) and 5(b), the following symbols have the following meanings: [symbol] is AveragePooling2D, [symbol] is Dropout, [symbol] is Sigmoid, [symbol] is ReLU, [symbol] is Softmax.

We chose smaller networks to reduce the runtime of our experiments. Performing accuracy evaluations on larger models is particularly time-consuming as we had to override the base TensorFlow modules to replace multiplication steps to approximate arithmetic blocks, as represented by the algorithm of FIG. 4(b).

Each network is first trained using full precision floating point values and then the inputs, weights and activations are quantized. Here, we have not used a quantization-aware training approach in order to measure the worst-case accuracy, which assumes a pre-trained model is applied directly to our APTPU. A non-approximate TPU with 8, 16, and 32 bits for IFMap/W is used here as a baseline. The validation accuracy results across all cases are provided in FIG. 5(c). In particular, FIG. 5(c) is a Table of bit precision comparison for APTPU vs. TPU accuracy. The non-approximate TPU baseline is labeled ‘Normal’. The average accuracy change from baseline to APTPU across datasets and bit-lengths for multiplier precision of k=3 is +0.49%, k=4 is +0.85%, k=5 is +0.42%, and k=6 is −0.17%, where k is the resolution of low-precision multiplier in APE. In general, the accuracy of the APTPU matches or outperforms the results of the non-approximate simulation for the former three values of multiplier precision. We expect this is due to the quantization and approximation noise acting as a regularizer to the neural network which can reduce overfitting [43], [44], [45]. For the more complex tasks, such as FMNIST and EMNIST classification, a lower bit-width degrades accuracy evenly across the high-precision baseline and the APTPU.

To verify that the high accuracy of the APTPU is a result of the approximation techniques that have been applied, and that similar accuracy values cannot be achieved by reducing the precision of MAC units, we evaluated the accuracy of baseline TPU with IFMap/W bits (n) from 3 to 6 bits without approximation. The low accuracy results of the low-precision baseline listed in FIG. 5(d) confirms that the high accuracy of the APTPU is a result of the approximation techniques. However, the accuracy of low-precision TPU can be potentially improved by training using quantization-aware techniques [4].

### B. Area and Power Consumption

Here, we investigate the area occupation and power consumption of the APTPU using Synopsys Design Compiler along with the 45 nm Nangate Open Cell Library. The timing constraints in all experiments are set to a clock period of 10 ns with an uncertainty of 2%, and a clock network delay of 1 ns. Our developed parameterizable RTL enabled the experiments to span across values k=3, 4, 5, 6 for the low-precision multiplier resolution with IFMap/W bitwidth (n) spanning between 8, 16, and 32, for differently sized systolic arrays S=8×8, 16×16, 32×32, and 64×64.

As the processing element is the most important module in the systolic array architecture, we measure the power consumption and area of our disclosed APE compared to the baseline TPU's PE and DRUM-based PE, in which a DRUM approximate multiplier [7] replaces the multiplier in baseline PEs. Sweeping across various values of input feature map and weight (IFMap/W) precision (n) and the low-precision multiplier resolution (k) gives an accurate estimate for the possible design options available. The Table of FIG. 5(e) exhibits the area and power consumption for each processing element (PE). The synthesis reports show that the disclosed APE achieves up to 75.6% and 49.2% area reduction compared to baseline PE and DRUM-based PE, respectively, and up to 82.8% and 32.5% decrease in power consumption compared to TPU PE and DRUM-based PE, respectively.

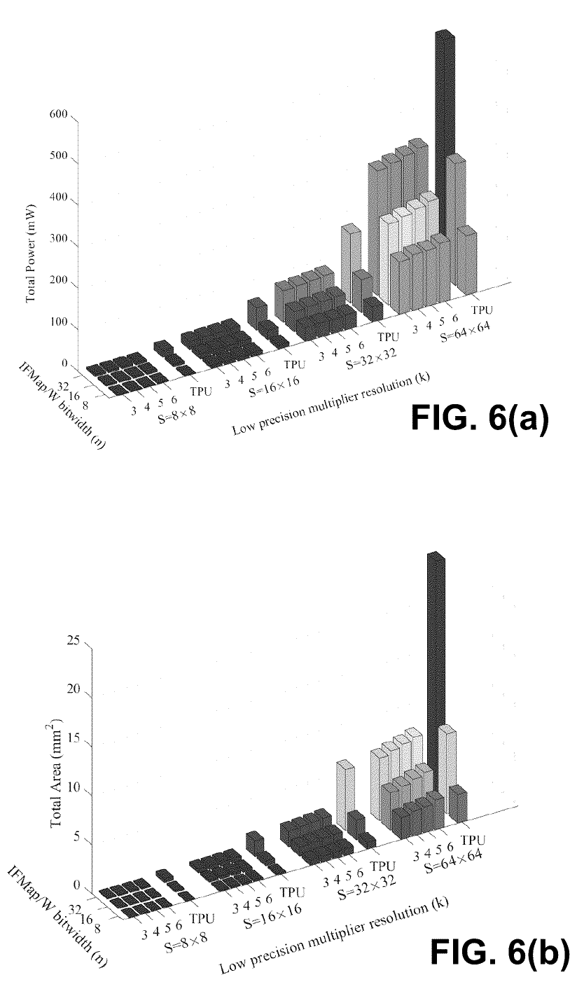

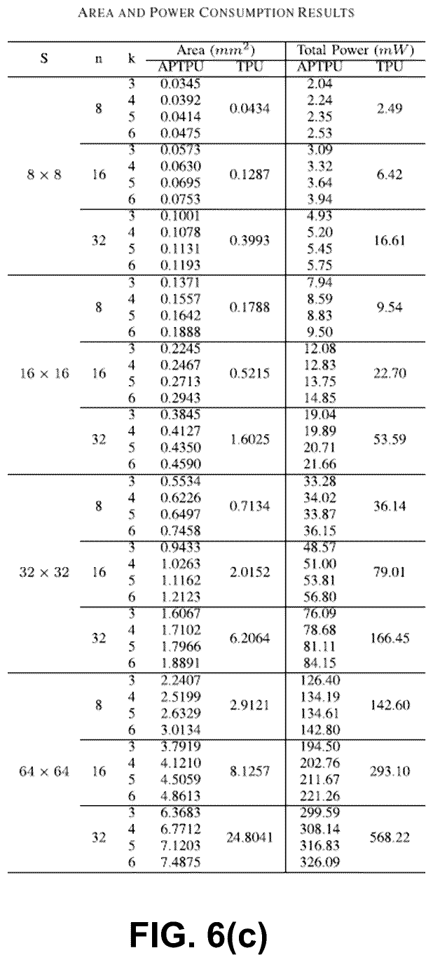

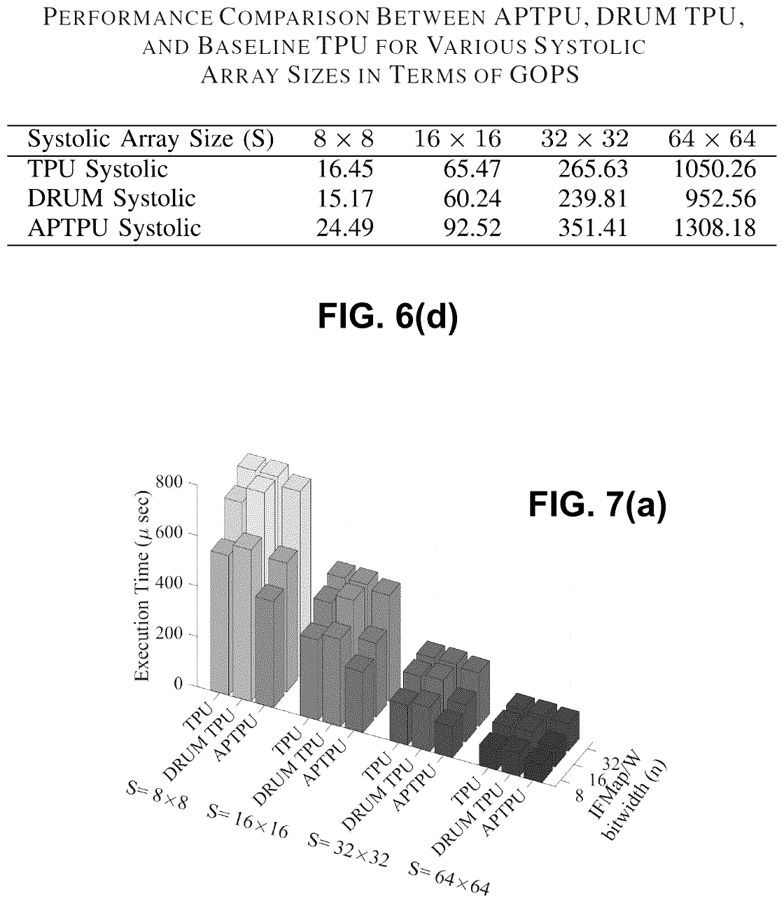

FIGS. 6(a) and 6(b) graphically represent hardware implementation results for power consumption (6(a)) and area (6(b)), respectively. FIG. 6(c) is a Table showing the power consumption and area occupation of the APTPU compared to the baseline TPU, where an average reduction of 41.3% and 55.3% are achieved, respectively, across all experiments. This can be attributed to two features: 1) the use of low-precision multipliers, and 2) the steering logic has been moved outside the matrix multiply unit to enable sharing between processing elements. Both of these contribute to the reduction of size of each APE as also reported in the Table of FIG. 5(e).

### C. Timing

The timing analysis is also performed in Synopsys Design Compiler. We use the non-approximate TPU as a baseline, in addition to a DRUM-based TPU, in which exact multipliers in the processing elements are simply replaced with a DRUM approximate multiplier, without leveraging shared PAUs to implement the steering logic. This allows us to separate the performance benefits that are only a result of using approximate units, from those that are a result of design reuse, i.e. sharing steering logic among APEs disclosed in the APTPU. FIG. 6(d) is a Table showing performance comparisons between APTPU, DRUM-TPU, and baseline TPU for various systolic array sizes in terms of giga operation per second (GOPS). The APTPU outperforms the non-approximate TPU and DRUM-TPU baselines under all conditions, while DRUM-TPU shows lower performance compared to baseline TPU. These results indicate that the timing improvement of our APTPU is not a direct result of approximate computing units, but rather, the use of shared PAUs disclosed herein.

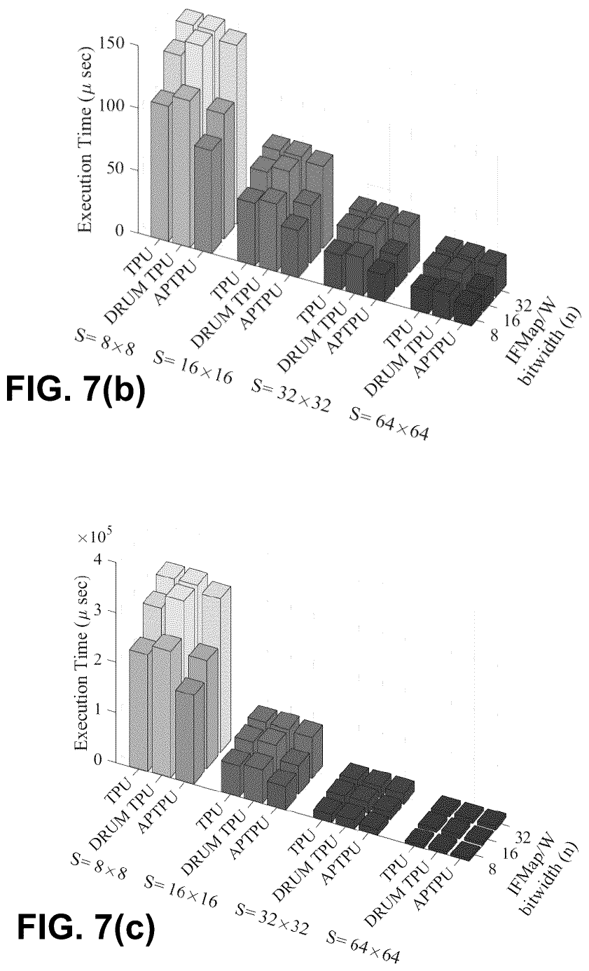

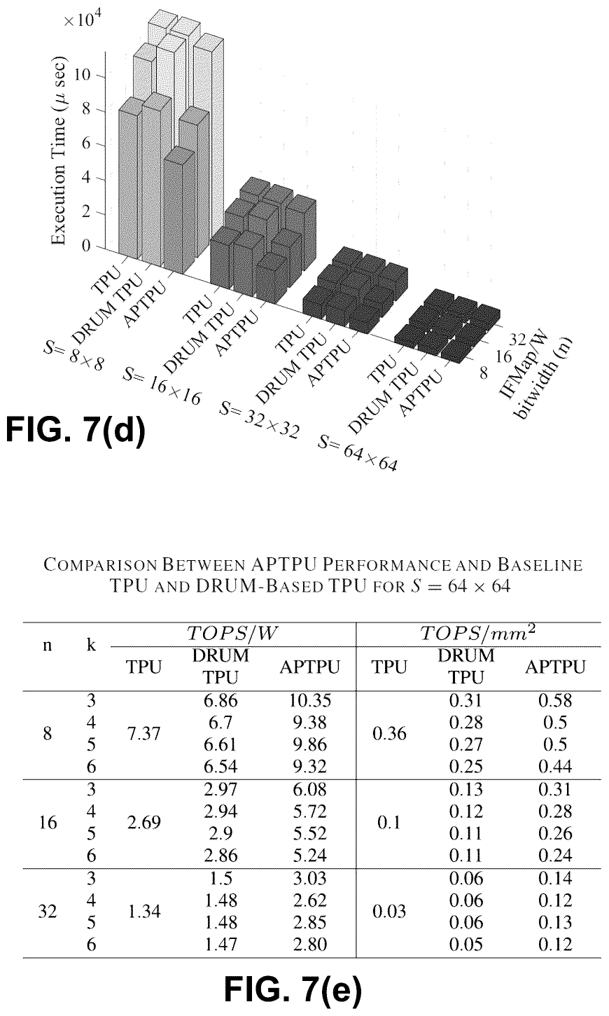

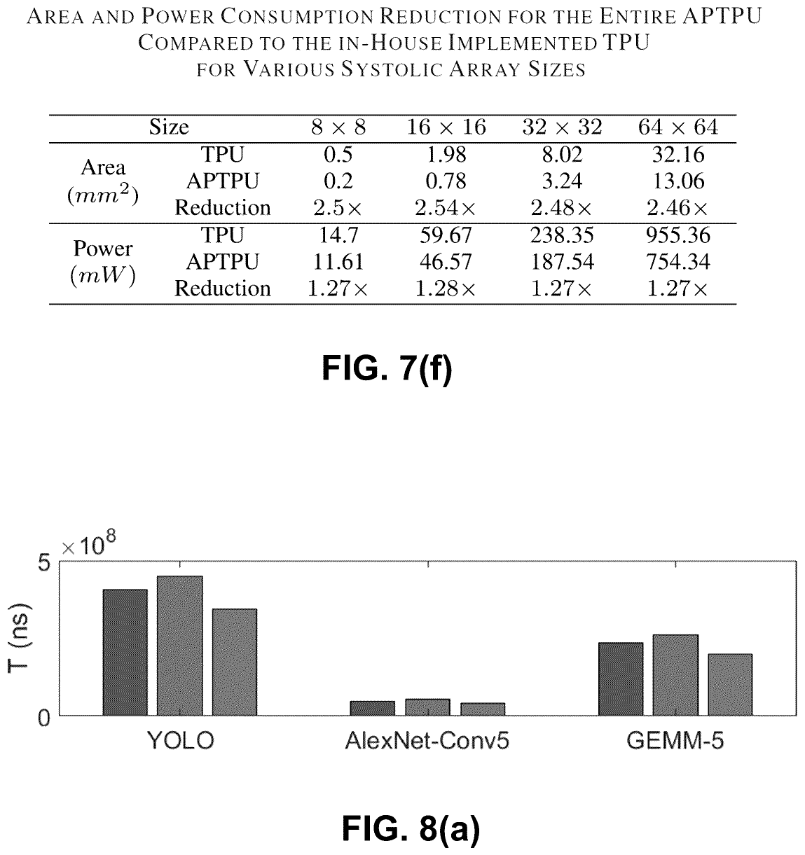

In addition, we employed SCALE-Sim [15], a cycle accurate simulator for machine learning accelerators, to obtain the required number of clock cycles for each layer in a variety of neural network architectures. As before, we used LeNet-5 and MLP5, but additionally obtained a cycle count on MobileNet [46] and YOLO-Tiny [47] to also assess performance on larger models for embedded deployment. The number of cycles is measured using the OS data flow regime of the APTPU and multiplied by the frequency obtained from the critical path timing measurements to find the total execution time, i.e., the time taken from passing an input image to the network to obtain an output at the final layer. FIGS. 7(a)-7(d) graphically illustrate the total execution time for various ML models for various Sand n values, specifically for various deep learning models on baseline TPU, DRUM TPU and APTPU, including MLP5 (FIG. 7(a)), LeNet-5 (FIG. 7(b)), YOLO-Tiny (FIG. 7(c)), and MobileNet (FIG. 7(d)), respectively.

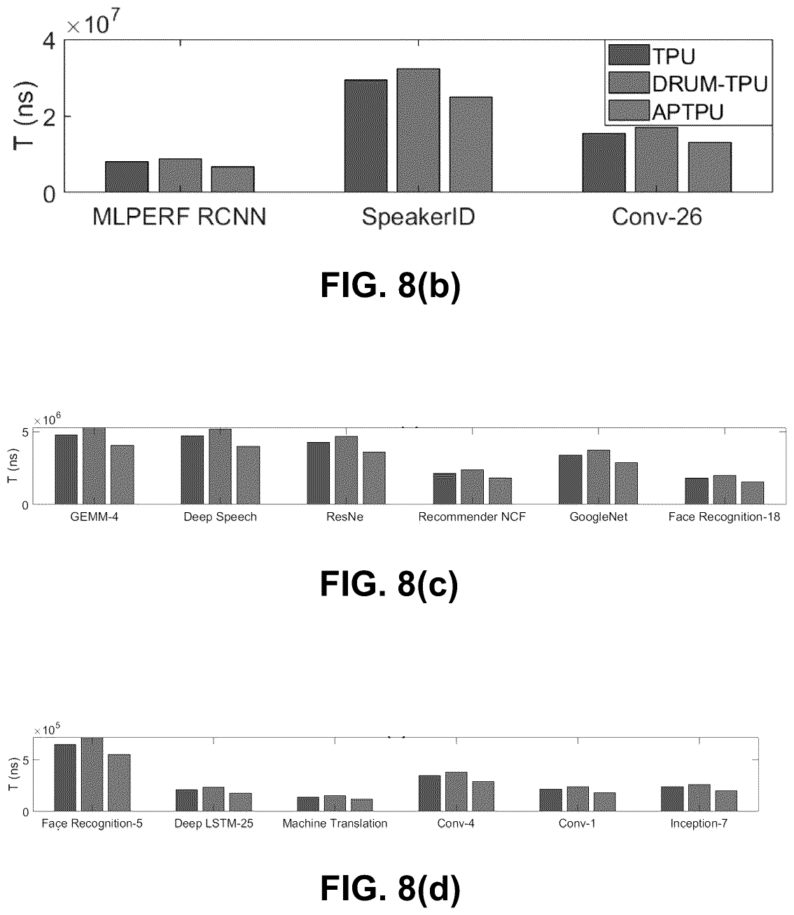

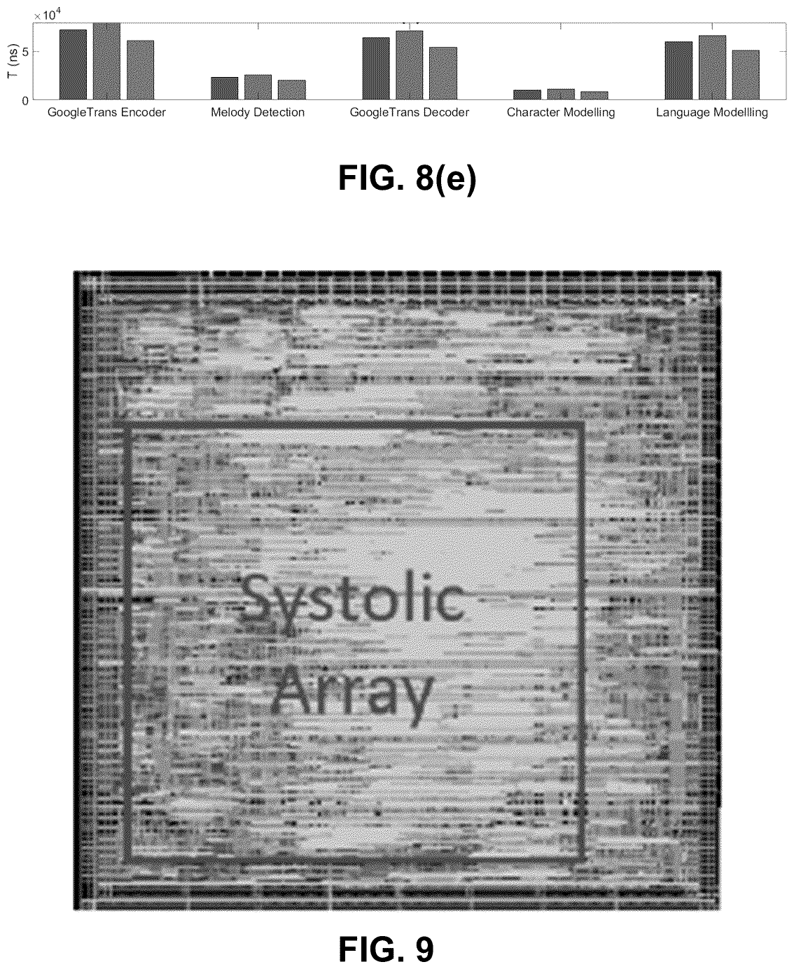

To exhibit the timing benefits of APTPU at scale, we extended our experiments to include a wide range of ML workloads and applications such as deep CNN models for face recognition, deep recurrent neural networks (RNNs) for speech recognition, transformers for language translations, and recommendation systems. The results are shown in FIGS. 8(a)-8(e), where the workloads are categorized into five classes based on the execution time. In particular, FIGS. 8(a)-8(e) graphically illustrate the execution time (T) of various workload on TPU, DRUM TPU, and APTPU, assuming S=64×64 and n=8, including very large (100 ms<T<1s) (FIG. 8(a)), large (10 ms<T<100 ms) (FIG. 8(b)), Medium (1 ms<T<10 ms) (FIG. 8(c)), Small (0.1 ms<T<1 ms) (FIG. 8(d)), and Very small (0.01 ms<T<0.1 ms) (FIG. 8(e)), respectively. We use the worst-case timing of the low-precision multiplier for our APTPU and the best-case for the baseline TPU and DRUM TPU. Regardless, our disclosed APTPU runs faster than both baselines for all test cases. In particular, the APTPU achieves an average of 1.4× and 1.5× speedup compared to baseline TPU and DRUM TPU, respectively, across all of the conducted experiments.

To provide a streamlined comparison that factors in timing, power consumption, and area, we calculated the TOPS/W and TOPS/mm². FIG. 7(e) is a Table providing performance comparisons between the TPU, DRUM-TPU, and APTPU, for S=64×64 using different IFMap/W bitwidths (n), and multiplier precision resolution (k). For all cases, our APTPU outperforms the baseline TPU and DRUM TPU. In particular, the APTPU achieves 1.2-4.4× and 1.4-2.4× improvement in TOPS/W compared to the baseline TPU and DRUM TPU, respectively. In terms of TOPS/mm², the APTPU achieves 1.2-5.3× and 1.8-2.7× improvement compared to TPU and DRUM TPU, respectively. As network bit precision is varied, the TOPS/W metric of all TPUs scales at a constant rate over the measured range, while for TOPS/mm², the APTPU improves at a faster rate than both the TPU and DRUM TPU as IFMap/W bitwidth (n) is decreased. In general, as n is doubled, the TOPS/mm² of baseline TPU drops approximately by a factor of 4, while that of the APTPU only drops by a factor of 2. Moreover, as listed in the Table of FIG. 7(e), increasing the multiplier precision resolution (k) in approximate MAC units can lead to a slight decrease in both TOPS/W and TOPS/mm² of the DRUM TPU and APTPU designs.

### E. System Analysis

As mentioned in Section III, the presently disclosed APTPU aims to improve the systolic array component of the TPU by replacing the large and power-hungry accurate MAC unit with an approximate MAC unit. Although the other components including FIFOs and controller are not improved in our approach, the systolic array itself is a crucial component and it occupies between 77%-80% of the entire TPU's area and consumes approximately, 50%-89% of its power consumption depending on the systolic array size (S), MAC unit precision (n), and the size of the low-precision multiplier (k).

FIG. 9 illustrates a plan view showing a presently disclosed in-house implemented TPU chip layout and exhibiting the placement of the systolic array component on the entire layout. The size of the systolic array in the presently disclosed in-house baseline TPU chip is S=8×8 and has been implemented using 65 nm technology at a clock frequency of 100 MHz. Moreover, we conducted additional experiments to assess the effect of the achieved systolic array improvements on the entire system. FIG. 7(f) is a Table listing the area and power consumption of our presently disclosed APTPU, including the entire system components, compared to the baseline TPU, all for various systolic array sizes. The results obtained show per the Table of FIG. 7(f) that the APTPU reduces the overall chip area and power consumption by approximately 2.5× and 1.2×, respectively.

### F. Comparison to the State-of-the-Art

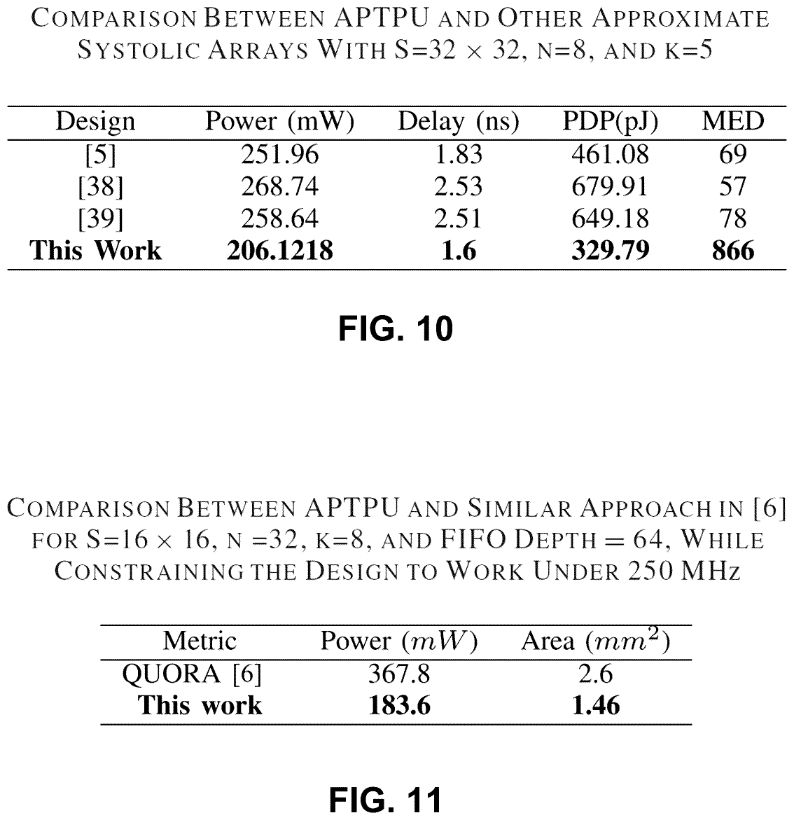

Here, we compare our presently disclosed APTPU with four other state-of-the-art approximate systolic arrays [5], [6], [38], [39]. For a fair comparison, we synthesize APTPU with the same design constraints and specifications existing in each of the previous designs in terms of IFMap/W precision (n), resolution of the low-precision multiplier (k), size of the systolic array (S), depth of the FIFO, and clock frequency. All the designs are synthesized using the 45 nm technology. In particular, FIG. 10 is a Table showing comparisons between our presently disclosed APTPU and other approximate systolic arrays. In particular, FIG. 10 shows comparisons for which the design hyperparameters are set as S=32×32, n=8, and k=5, which are the values used in [39]. The approximate computing scheme in [39] is based on replacing the full adder in the Baugh-Wooley multiplier and the accumulator with an approximate full adder. A similar approach has been adopted in [5] and [38], in which they disclosed approximate partial product units (PPUs) and approximate adder and utilized them in the design of the PE of the systolic array. Using their disclosed approximation approach, they could shrink the critical path of the PE with a few modifications in its microarchitecture at the cost of a static approximation error.

On the other hand, the approximate scheme used in the presently disclosed APTPU is dynamic and the error is mostly affecting the least significant bits. Additionally, our presently disclosed APTPU utilizes shared pre-approximate units (PAUs) along with approximate adders which further reduce the critical path delay of the entire systolic array. As listed in FIG. 10, our presently disclosed APTPU achieves 1.14×-1.58× and 1.4×-2× reduction in the delay and power-delay-product (PDP) value, respectively, compared to the other approximate systolic arrays. It should be noted that, as listed in the last column of the FIG. 10, the APTPU architecture introduces more Mean Error Distance (MED) compared to the previous designs for isolated matrix multiplications. However, as elaborated in Section IV.A, these errors are averaged out and reduced over multiple cycles and do not impact the performance of the presently disclosed APTPU while used for error-tolerant ML applications that are the targeted workloads for TPUs. Therefore, over-optimizing the design to gain better accuracy for matrix multiplication is not necessary.

QUORA is another approximate systolic array architecture disclosed in [6] that utilizes shared precision scaling units as well as approximate processing elements (APEs). QUORA has four different precision scaling schemes namely, up/down precision scaling, precision scaling with error monitoring, precision scaling with error compensation, and dynamic precision scaling. The precision scaling approaches truncate some number of least significant bits from the operands; thus, parts of the PEs can be disabled through power gating or clock gating mechanisms, which results in power savings. However, as opposed to our presently disclosed APTPU, their APE operates over multiple clock cycles and its functionality is determined by some control signals due to having different functional units. In contrast, the APE in our presently disclosed APTPU has a low precision multiplier and an approximate adder with no control overhead. FIG. 11 is a Table of comparisons between our presently disclosed APTPU and OUORA approach in [6], expressed for a systolic array of the size S=16×16, n=32, k=8, and FIFO depth=64, while constraining the design to work under 250 MHz similar to [6] for a fair comparison. As listed in the Table of FIG. 11, even while constraining the design to work with 250 MHz, our presently disclosed APTPU achieves 2× and 1.78× reduction in power consumption and area, respectively, for the systolic array of the size S=16×16, n=32, k=8, and FIFO depth=64 design specifications used in [6].

### V. Conclusion

We disclose an approach to leveraging approximate arithmetic logic units within the TPU architecture. The shareable components of the approximate circuits are integrated into the pre-approximate units (PAUs), and re-used among the approximate processing elements (APEs) in the systolic array. This enables significant improvements compared to baseline TPU architectures, as well as TPU designs that simply replace MAC units with approximate units. Our simulations span across a broad design space while quantifying the trade-offs in using approximate logic for a variety of machine learning workloads. We perform a comprehensive analysis across neural network accuracy, timing, area, power, and performance. We show that our presently disclosed APTPU outperforms conventional designs in terms of area, power, and timing while realizing comparable accuracy. In particular, the presently disclosed APTPU's approximate systolic array achieves up to 5.2×TOPS/W and 4.4×TOPS/mm² improvement compared to that of a conventional TPU architecture, while the entire presently disclosed APTPU system achieves a reduction of 2.5× and 1.2× area and power consumption, respectively. Furthermore, simulation results and synthesis report obtained show that the approximation scheme in the presently disclosed APTPU achieves a significant reduction in power, delay, and area compared to four of the most efficient approximate systolic arrays in the literature while using similar design specifications and synthesis constraints. Future development will focus on implementing a mixed-precision APTPU which supports a variety of data flow architectures.

While certain embodiments of the disclosed subject matter have been described using specific terms, such description is for illustrative purposes only, and it is to be understood that changes and variations may be made without departing from the spirit or scope of the subject matter.

### REFERENCES

[1] N. P. Jouppi et al., “In-datacenter performance analysis of a tensor processing unit,” in Proc. 44th Annu. Int. Symp. Comput. Archit., 2017, pp. 1-12.
[2] N. Jouppi, C. Young, N. Patil, and D. Patterson, “Motivation for and evaluation of the first tensor processing unit,” IEEE Micro, vol. 38, no. 3, pp. 10-19, May/June 2018.
[3] X. Lin, C. Zhao, and W. Pan, “Towards accurate binary convolutional neural network,” 2017, arXiv:1711.11294.
[4] J. Lee, J. K. Eshraghian, S. Kim, K. Eshraghian, and K. Cho, “Quantized convolutional neural network implementation on a parallel-connected memristor crossbar array for edge AI platforms,” J. Nanosci. Nanotechnol., vol. 21, no. 3, pp. 1854-1861, March 2021.
[5] H. Waris, C. Wang, W. Liu, and F. Lombardi, “AxSA: On the design of high-performance and power-efficient approximate systolic arrays for matrix multiplication,” J. Signal Process. Syst., vol. 93, no. 6, pp. 605-615, June 2021.
[6] S. Venkataramani, V. K. Chippa, S. T. Chakradhar, K. Roy, and A. Raghunathan, “Quality programmable vector processors for approximate computing,” in Proc. 46th Annu. IEEE/ACM Int. Symp. Microarchitecture (MICRO), December 2013, pp. 1-12.
[7] S. Hashemi, R. I. Bahar, and S. Reda, “DRUM: A dynamic range unbiased multiplier for approximate applications,” in Proc. IEEE/ACM Int. Conf. Comput.-Aided Design (ICCAD), November 2015, pp. 418-425.
[8] A. Dalloo, A. Najafi, and A. Garcia-Ortiz, “Systematic design of an approximate adder: The optimized lower part constant—Or adder,” IEEE Trans. Very Large Scale Integr. (VLSI) Syst., vol. 26, no. 8, pp. 1595-1599, August 2018.
[9] J. Shen, H. Ren, Z. Zhang, J. Wu, W. Pan, and Z. Jiang, “A high-performance systolic array accelerator dedicated for CNN,” in Proc. IEEE 19th Int. Conf. Commun. Technol. (ICCT), October 2019, pp. 1200-1204.
[10] S. Lym and M. Erez, “FlexSA: Flexible systolic array architecture for efficient pruned DNN model training,” 2020, arXiv:2004.13027.
[11] S. Guo et al., “A systolic SNN inference accelerator and its co-optimized software framework,” in Proc. Great Lakes Symp. VLSI, May 2019, pp. 63-68.
[12] Y. H. Chen, T. Krishna, J. S. Emer, and V. Sze, “Eyeriss: An energy efficient reconfigurable accelerator for deep convolutional neural networks,” IEEE J. Solid-State Circuits, vol. 52, no. 1, pp. 127-138, May 2017.
[13] E. Qin et al., “SIGMA: A sparse and irregular GEMM accelerator with flexible interconnects for DNN training,” in Proc. IEEE Int. Symp. High Perform. Comput. Archit. (HPCA), February 2020, pp. 58-70.
[14] H. Lim, V. Piuri, and E. E. Swartzlander, “A serial-parallel architecture for two-dimensional discrete cosine and inverse discrete cosine transforms,” IEEE Trans. Comput., vol. 49, no. 12, pp. 1297-1309, December 2000.
[15] A. Samajdar, Y. Zhu, P. Whatmough, M. Mattina, and T. Krishna, “SCALE-Sim: Systolic CNN accelerator simulator,” 2018, arXiv:1811.02883.
[16] J. N. Mitchell, “Computer multiplication and division using binary logarithms,” IRE Trans. Electron. Comput., vol. 11, no. 4, pp. 512-517, August 1962.
[17] B.-G. Nam, H. Kim, and H.-J. Yoo, “Power and area-efficient unified computation of vector and elementary functions for handheld 3D graphics systems,” IEEE Trans. Comput., vol. 57, no. 4, pp. 490-504, April 2008.
[18] M. B. Sullivan and E. E. Swartzlander, “Truncated error correction for flexible approximate multiplication,” in Proc. Conf. Rec. Forty 6th Asilomar Conf. Signals, Syst. Comput. (ASILOMAR), November 2012, pp. 355-359.
[19] K. Bhardwaj, P. S. Mane, and J. Henkel, “Power- and area-efficient approximate Wallace tree multiplier for error-resilient systems,” in Proc. 15th Int. Symp. Quality Electron. Design, March 2014, pp. 263-269.
[20] B. Boro, K. M. Reddy, Y. B. N. Kumar, and M. H. Vasantha, “Approximate radix-8 booth multiplier for low power and high speed applications,” Microelectron. J., vol. 101, July 2020, Art. no. 104816.
[21] W. Liu, L. Qian, C. Wang, H. Jiang, J. Han, and F. Lombardi, “Design of approximate radix-4 booth multipliers for error-tolerant computing,” IEEE Trans. Comput., vol. 66, no. 8, pp. 1435-1441, August 2017.
[22] M. Amudha and K. Sivasubramanian, “Design of low-error fixed-width modified booth multiplier,” Int. J. Electron. Comput. Sci. Eng., vol. 1, no. 2, pp. 522-531, 2012.
[23] J. P. Wang, S. R. Kuang, and S. C. Liang, “High-accuracy fixed-width modified booth multipliers for lossy applications,” IEEE Trans. Very Large Scale Integr. (VLSI) Syst., vol. 19, no. 1, pp. 52-60, January 2011.
[24] M. E. Elbtity, H.-W. Son, D.-Y. Lee, and H. Kim, “High speed, approximate arithmetic based convolutional neural network accelerator,” in Proc. Int. SoC Design Conf. (ISOCC), October 2020, pp. 71-72.
[25] V. Kumar and R. Kant, “Approximate computing for machine learning,” in Proc. 2nd Int. Conf. Commun., Comput. Netw., 2019, pp. 607-613.
[26] H. Younes, A. Ibrahim, M. Rizk, and M. Valle, “Algorithmic level approximate computing for machine learning classifiers,” in Proc. 26th IEEE Int. Conf. Electron., Circuits Syst. (ICECS), November 2019, pp. 113-114.
[27] P. Yin, C. Wang, H. Waris, W. Liu, Y. Han, and F. Lombardi, “Design and analysis of energy-efficient dynamic range approximate logarithmic multipliers for machine learning,” IEEE Trans. Sustain. Comput., vol. 6, no. 4, pp. 612-625, October 2021.
[28] M. S. Ansari, B. F. Cockburn, and J. Han, “An improved logarithmic multiplier for energy-efficient neural computing,” IEEE Trans. Comput., vol. 70, no. 4, pp. 614-625, April 2021.
[29] W. Liu, J. Xu, D. Wang, C. Wang, P. Montuschi, and F. Lombardi, “Design and evaluation of approximate logarithmic multipliers for low power error-tolerant applications,” IEEE Trans. Circuits Syst. I, Reg. Papers, vol. 65, no. 9, pp. 2856-2868, September 2018.
[30] H. Mo et al., “A 1.17 TOPS/W, 150 fps accelerator for multi-face detection and alignment,” in Proc. 56th Annu. Design Autom. Conf., June 2019, pp. 1-6.
[31] H. Jiang, F. J. H. Santiago, H. Mo, L. Liu, and J. Han, “Approximate arithmetic circuits: A survey, characterization, and recent applications,” Proc. IEEE, vol. 108, no. 12, pp. 2108-2135, December 2020.
[32] P. Balasubramanian and D. L. Maskell, “Hardware optimized and error reduced approximate adder,” Electronics, vol. 8, no. 11, p. 1212, October 2019.
[33] R. Nayar, P. Balasubramanian, and D. L. Maskell, “Hardware optimized approximate adder with normal error distribution,” in Proc. IEEE Comput. Soc. Annu. Symp. VLSI (ISVLSI), July 2020, pp. 84-89.
[34] V. Gupta, D. Mohapatra, A. Raghunathan, and K. Roy, “Low-power digital signal processing using approximate adders,” IEEE Trans. Comput.-Aided Design Integr. Circuits Syst., vol. 32, no. 1, pp. 124-137, January 2013.
[35] S. Mittal, “A survey of techniques for approximate computing,” ACM Comput. Surv., vol. 48, no. 4, pp. 1-33, 2016.
[36] I. C. Lin, Y. M. Yang, and C. C. Lin, “High-performance low-power carry speculative addition with variable latency,” IEEE Trans. Very Large Scale Integr. (VLSI) Syst., vol. 23, no. 9, pp. 1591-1603, September 2015.
[37] P. L. Lahari, M. Bharathi, and Y. J. Shirur, “An efficient truncated MAC using approximate adders for image and video processing applications,” in Proc. 4th Int. Conf. Trends Electron. Informat. (ICOEI), June 2020, pp. 1039-1043.
[38] H. Waris, C. Wang, W. Liu, and F. Lombardi, “Design and evaluation of a power-efficient approximate systolic array architecture for matrix multiplication,” in Proc. IEEE Int. Workshop Signal Process. Syst. (SiPS), October 2019, pp. 13-18.
[39] K. Chen, F. Lombardi, and J. Han, “Matrix multiplication by an inexact systolic array,” in Proc. IEEE/ACM Int. Symp. Nanosc. Archit., July 2015, pp. 151-156.
[40] Y. LeCun, L. Bottou, Y. Bengio, and P. Haffner, “Gradient-based learning applied to document recognition,” Proc. IEEE, vol. 86, no. 11, pp. 2278-2324, November 1998.
[41] G. Cohen, S. Afshar, J. Tapson, and A. van Schaik, “EMNIST: Extending MNIST to handwritten letters,” in Proc. Int. Joint Conf. Neural Netw. (IJCNN), May 2017, pp. 2921-2926.
[42] H. Xiao, K. Rasul, and R. Vollgraf, “Fashion-MNIST: A novel image dataset for benchmarking machine learning algorithms,” 2017, arXiv:1708.07747.
[43] X. Xu et al., “Quantization of fully convolutional networks for accurate biomedical image segmentation,” in Proc. IEEE/CVF Conf. Comput. Vis. Pattern Recognit., June 2018, pp. 8300-8308.
[44] A. Zhou, A. Yao, Y. Guo, L. Xu, and Y. Chen, “Incremental network quantization: Towards lossless CNNs with low-precision weights,” in Proc. Int. Conf. Learn. Represent. (ICLR), 2017, pp. 1-14.
[45] T. Liang, J. Glossner, L. Wang, S. Shi, and X. Zhang, “Pruning and quantization for deep neural network acceleration: A survey,” Neurocomputing, vol. 461, pp. 370-403, October 2021.
[46] A. G. Howard et al., “MobileNets: Efficient convolutional neural networks for mobile vision applications,” 2017, arXiv:1704.04861.
[47] P. Adarsh, P. Rathi, and M. Kumar, “YOLO v3-Tiny: Object detection and recognition using one stage improved model,” in Proc. 6th Int. Conf. Adv. Comput. Commun. Syst. (ICACCS), March 2020, pp. 687-694.

What is claimed is:

1. A neural network approximate tensor processing unit (APTPU) based systolic array architecture, comprising
input memory having stored data;
data queues;
a controller for managing the transfer of stored data from the input memory to the data queues;
a plurality of approximate processing elements (APEs) each respectively including a low-precision multiplier and an approximate adder; and
a plurality of pre-approximate units (PAUs) which are respectively shared among the APEs in the systolic array.

2. Architecture according to claim 1, wherein the PAUs comprise steering logic to pre-process operands input to the systolic array and feed them to the APEs.

3. Architecture according to claim 2, wherein the PAUs handle the steering logic in approximate multipliers, in which operands from the data queues with relatively higher precision are dynamically truncated to relatively lower precision ones and transferred to APEs.

4. Architecture according to claim 3, wherein the relatively higher precision operands comprise at least 32 bit data, and the relatively lower precision multiplier ones comprise no more than 4 bit data.

5. Architecture according to claim 3, wherein the APEs further include a Barrel shifter interoperative with the low-precision multiplier and approximate adder to realize multiply and accumulation (MAC) operations.

6. Architecture according to claim 1, wherein each PAU is situated in dataflow between the data queues and each APE, and shared among the APEs across different rows and columns of the systolic array.

7. Architecture according to claim 1, wherein:
the input memory and stored data comprise respective weight memory and IFMap memory, for storing a neural network model's weights and inputs, respectively; and
the controller manages the streaming of both stored neural network model weights and inputs into the APEs according to an output stationary (OS) systolic array data flow algorithm.

8. Architecture according to claim 7, wherein each PAU includes a plurality of registers for outputting truncated bits, shift amounts, and signs of each operand from the corresponding PAUs.

9. Architecture according to claim 3, wherein:
the input memory and stored data comprise respective weight memory and IFMap memory, for storing a neural network model's weights and inputs, respectively;
the controller manages the transfer of stored neural network model weights and inputs according to an output stationary (OS) systolic array data flow algorithm; and
the low-precision multiplier resolution values k range from 3 to 6, with IFMap/W bitwidth (n) spanning between 8, 16, and 32, for differently sized systolic arrays of S=8×8, 16×16, 32×32, and 64×64.

10. Architecture according to claim 1, wherein the size of the systolic array is S=8×8, with 65 nm technology operated at a clock frequency of 100 MHz.

11. Architecture according to claim 3, wherein the approximate multipliers comprise respective dynamic range unbiased multipliers (DRUMs).

12. Methodology for operating an approximate tensor processing unit (APTPU) systolic array for improved neural network Artificial Intelligence (AI) through AI acceleration, comprising:
providing a plurality of approximate processing elements (APEs) each respectively including a low-precision multiplier and an approximate adder; and
providing a plurality of pre-approximate units (PAUs) which have integrated shareable approximate circuit components which are re-used among the approximate processing elements (APEs) in the systolic array, wherein the PAUs comprise steering logic to pre-process operands input to the systolic array and feed them to the APEs.

13. Methodology according to claim 12, wherein the integrated shareable approximate circuit components comprise in-exact processing elements that have relatively smaller sizes and consume less power than conventional processing elements, to enable the deployment of artificial intelligence models on relatively smaller (Internet-of-Things) IOT devices.

14. Methodology for a neural network approximate tensor processing unit (APTPU) based systolic array architecture, comprising
providing input memory having stored data;
providing a plurality of data queues;
providing a controller programmed for managing the transfer of stored data from the input memory to the data queues;
providing a plurality of approximate processing elements (APEs) each respectively including a low-precision multiplier and an approximate adder; and
providing a plurality of pre-approximate units (PAUs) which are respectively shared among the APEs in the systolic array.

15. Methodology according to claim 14, wherein the PAUs comprise steering logic to pre-process operands input to the systolic array and feed them to the APEs.

16. Methodology according to claim 15, wherein the PAUs handle the steering logic in approximate multipliers, in which operands from the data queues with relatively higher precision are dynamically truncated to relatively lower precision ones and transferred to APEs.

17. Methodology according to claim 16, wherein the relatively higher precision operands comprise at least 32 bit data, and the relatively lower precision multiplier ones comprise no more than 4 bit data.

18. Methodology according to claim 16, wherein the APEs further include a Barrel shifter interoperative with the low-precision multiplier and approximate adder to realize multiply and accumulation (MAC) operations.

19. Methodology according to claim 14, wherein each PAU is situated in dataflow between the data queues and each APE, and shared among the APEs across different rows and columns of the systolic array.

20. Methodology according to claim 14, wherein:
the input memory and stored data comprise respective weight memory and IFMap memory, for storing a neural network model's weights and inputs, respectively; and
the controller manages the streaming of both stored neural network model weights and inputs into the APEs according to an output stationary (OS) systolic array data flow algorithm.

21. Methodology according to claim 20, wherein each PAU includes a plurality of registers for outputting truncated bits, shift amounts, and signs of each operand from the corresponding PAUs.

22. Methodology according to claim 16, wherein:
the input memory and stored data comprise respective weight memory and IFMap memory, for storing a neural network model's weights and inputs, respectively;
the controller manages the transfer of stored neural network model weights and inputs according to an output stationary (OS) systolic array data flow algorithm; and
the low-precision multiplier resolution values k range from 3 to 6, with IFMap/W bitwidth (n) spanning between 8, 16, and 32, for differently sized systolic arrays of S=8×8, 16×16, 32×32, and 64×64.

23. Methodology according to claim 14, wherein the size of the systolic array is S=8×8, with 65 nm technology operated at a clock frequency of 100 MHz.

24. Methodology according to claim 16, wherein the approximate multipliers comprise respective dynamic range unbiased multipliers (DRUMs).
